(19) United States
(12) Patent Application Publication
(10) Pub. No.: US 2006/0233864 A1
(43) Pub. Date: Oct. 19, 2006

(54) Methods for improving the nutritional quality of residues of the fuel, beverage alcohol, food and feed industries

(76) Inventor: Ronan F. Power, Lexington, KY (US)

Correspondence Address: KING & SCHICKLI, PLLC, 247 NORTH BROADWAY, LEXINGTON, KY, 40507, US

(21) Appl. No.: 10/554,166

(22) PCT Filed: May 12, 2004
(86) PCT No.: PCT/US04/14735

§ 371 Date: Oct. 21, 2005

Related U.S. Application Data
(60) Provisional application No. 60/469,712, filed on May 12, 2003.

(51) Int. Cl. A23K 1/165

(52) U.S. Cl. 424/442; 426/53

(57) ABSTRACT

A method is provided for improving the nutritional quality of a fibrous by-product or residue of a food manufacturing process, wherein the fibrous by-product or residue is inoculated with at least one filamentous fungus, and the fibrous by-product or residue is fermented thereby to decrease dry matter content, increase protein content, and decrease fat content of the by-product or residue. Suitable byproducts or residues include spent brewer's grains, dried distiller's grains, dried distiller's solubles, distiller's dried grains with solubles, residues of the cereal processing industry, wheat bran, soybean hulls, citrus pulp, beet pulp, rice husks or hulls, bagasse, apple pommace, and combinations thereof. Enzymes produced during the fermentation may also be used as valuable coproducts such as animal feed supplements, or may be used in primary fermentations for the brewing and distilling industry.

This application claims the benefit of U.S. Provisional Patent Application Ser. No. 60/469,712 filed May 12, 2003, the disclosure of which is incorporated herein by reference.

### TECHNICAL FIELD

This invention relates broadly to novel methods for improving nutritional characteristics of fibrous food products. In particular, the invention relates to novel methods for improving the nutritional characteristics of a by-product or residue of a food or feed manufacturing process, including the beverage and fuel alcohol industries, and to compositions obtained thereby. Still further, the invention relates to methods for formulating nutritionally useful feed additives as co-products of the above-referenced methods for improving nutritional characteristics of a fibrous food product.

### BACKGROUND OF THE INVENTION

It is known to use various byproducts and residues of the food manufacturing industries, particularly fibrous byproducts and residues, for animal feeds. For example, due to the rapid growth of the distilling industry, the quantity of residues produced thereby is increasing dramatically each year and with it, the need for new and improved uses for such waste materials. In, for example, the distilling industry, alcohol production from corn grain involves the fermentative conversion of starch to alcohol. The fermented mash is then distilled to remove the alcohol. The remaining slurry contains 5 to 10% dry matter (DM) and is referred to as whole or spent stillage. Currently the majority of whole stillage is processed by various techniques to remove the large volume of water associated with the residual DM.

The initial step in this processing involves either screening and pressing or centrifuging to remove the coarser particles which are then dried. This fraction is termed dried distillers grains (DDG). The liquid fraction (5% DM) remaining after screening and centrifuging contains fine grain particles and yeast cells, and is termed thin stillage. Thin stillage is generally evaporated to produce a syrup, containing 30-40% DM, which is referred to in the industry as condensed distillers solubles (CDS). The CDS may be further dried to produce dried distillers solubles (DDS), or it may be added back to distillers grains and dried to form dried distillers grains with solubles (DDGS)

Similarly, the by-products and residues of other food manufacturing industries, such as the cereal processing industry, represent a source of potentially valuable raw materials for food and feed products. Examples of suitable by-products of the cereal processing industry include, but are not limited to, wheat bran and soybean hulls.

Distillers residues or byproducts, as well as by-products of cereal and other food industry manufacturing, are known to have a certain value as sources of protein and energy for animal feed. However, it is known that such products, having been subjected to various manufacturing and fermentative processes, tend to be lower in protein than conventional animal feeds such as soybean meal. Also, in the field of ruminant nutrition, during the past number of years, it has been realized that the primary value of a protein source is its bypass value. Bypass protein is the protein that escapes digestion in the rumen. This protein is subsequently digested in the intestinal tract, with enhanced nutritive value to the animal consuming it. Protein degraded in the rumen to ammonia is similar to urea in nutritional value. Soybean meal (SBM) is the most common protein source for ruminants. However, only 25-30% of SBM protein bypasses the rumen. While studies suggest that the relative bypass value of DDG and DDGS is higher than that of SBM, both products are lower in protein than soybean meal and in general considered less desirable as animal feeds, particularly for ruminants.

It is clear that any method for improving the overall protein content of by-products or residues such as DDG or DDGS, thus bringing them closer to SBM in terms of total protein content, would greatly add to the value of these products and might render them superior to SBM in terms of bypass protein value.

There is accordingly a need in the art for methods for improving the nutritional characteristics of by-products or residues of food/feed manufacturing processes for use as animal feeds, thereby improving the benefits of feed products derived therefrom to animals consuming them. Such methods, in addition to providing a value-added product for animal consumption, would allow a formerly waste product to find a second use in the agricultural industries, improving overall efficiency and utilization of resources thereby.

### SUMMARY OF THE INVENTION

In accordance with the purposes of the present invention as described herein, in one aspect of the present invention a method is provided for improving the nutritional quality of a fibrous by-product or residue of a food manufacturing process, comprising inoculating the fibrous by-product or residue with at least one filamentous fungus, and fermenting the fibrous by-product or residue whereby a dry matter content of the by-product or residue decreases, a protein content of the by-product or residue increases, and a fat content of the by-product or residue decreases. The filamentous fungus may be selected from the group consisting of Rhizopus, Aspergillus, Trichoderma, and any combination thereof. The fibrous by-product or residue may be selected from the group consisting of spent brewer's grains, dried distiller's grains, dried distiller's solubles, distiller's dried grains with solubles, residues of the cereal processing industry, wheat bran, soybean hulls, citrus pulp, beet pulp, rice husks or hulls, bagasse, apple pommace, and mixtures thereof.

Typically, the dry matter content of the fermented byproduct will be decreased by about 7% to about 12%, the protein content will be increased by about 10% to about 15%, and the fat content will be decreased by about 40% to about 50%. Fiber (neutral detergent fiber; NDF) content also decreases by about 10% to about 15%. However, it will be appreciated by those of skill in the art that different animals will have differing optimal requirements for those nutrients, and that altering fermentation times and conditions will allow tailoring the final fermented product in accordance with those nutritive needs without need for undue levels of experimentation. The fermentation step will typically be conducted as a solid-state fermentation, using the fibrous byproduct or residue as a substrate for growth of the filamentous fungus. Suitable reactors and conditions for such solid state fermentations are known in the art.

In another aspect, the present invention provides a method for producing an animal feed and an enzyme-based animal feed supplement from a fibrous by-product or residue of a food manufacturing process, comprising inoculating the fibrous by-product or residue with at least one filamentous fungus, fermenting the fibrous by-product or residue whereby a dry matter content of the by-product or residue decreases, a protein content of the by-product or residue increases, and a fat content of the by-product or residue decreases, separating at least one enzyme from the fermented fibrous by-product or residue; and providing the fermented fibrous by-product or residue and optionally the separated enzyme to an animal as a feed or feed supplement. Use of exogenous enzymes to increase digestibility or nutritive value of a feed source is known in this art. It will be appreciated that the separated enzyme may also find use in such arts as the brewing and distilling industry, for use in primary fermentations thereof. Indeed, an enzyme produced as described above, on a byproduct or residue of the brewing or distilling industry, may be particularly suited to subsequent use in brewing or distilling fermentations, as it was specifically produced by the organism to digest that substrate. Suitable fibrous by-products or residues and filamentous fungi are as described above. The separated enzyme is typically of fungal origin, and in one embodiment of the invention is a fungal protease.

In yet another aspect of the invention, an enzyme-containing animal feed or feed supplement is provided, produced by the steps of inoculating a fibrous byproduct or residue of a food manufacturing process with at least one filamentous fungus, and fermenting the fibrous byproduct or residue whereby a dry matter content of the byproduct or residue decreases, a protein content of the byproduct or residue increases, a fat content of the byproduct or residue decreases, and at least one enzyme of fungal origin is introduced into the fermented byproduct or residue. This feed or feed supplement may then be provided to an animal.

In still yet another aspect of the present invention, a method is provided for improving body weight gain rate of a growing animal, comprising feeding a nutritionally effective amount of an enzyme-based animal feed supplement formulated by the steps of inoculating a fibrous byproduct or residue of a food manufacturing process with at least one filamentous fungus, fermenting the fibrous byproduct or residue whereby a dry matter content of the byproduct or residue decreases, a protein content of the byproduct or residue increases, and a fat content of the byproduct or residue decreases, separating at least one enzyme from the fermented fibrous byproduct or residue, dewatering the separated enzyme, and providing the dewatered enzyme to an animal in a formulation comprising a suitable carrier. Suitable fibrous by-products or residues and fungi are as described above. The feed or feed supplement may be provided to any animal, including those selected from the group of species consisting of avian, bovine, porcine, equine, ovine, caprine, canine, and feline.

As should be appreciated, the embodiments shown and described are an illustration of one of the modes best suited to carry out the invention. It will be realized that the invention is capable of modification in various, obvious aspects all without departing from the invention. Accordingly, the drawings and descriptions will be regarded as illustrative in nature, and not as restrictive.

### BRIEF DESCRIPTION OF THE DRAWINGS

The accompanying drawings incorporated in and forming a part of the specification, illustrate several aspects of the present invention and together with the description serve to explain the principles of the invention. In the drawings:

FIG. 1 shows decreased substrate dry matter content during fermentation of DDGS by Rhizopus oligosporous 2UV3 over a 120 hour period;

FIG. 2 shows protease activity produced during fermentation of DDGS by Rhizopus oligosporous 2UV3 over a 120 hour period;

FIG. 3 demonstrates increases in substrate protein content during fermentation of DDGS by Rhizopus oligosporous 2UV3 over a 120 hour period;

FIG. 4 demonstrates decreases in substrate NDF content during fermentation of DDGS by Rhizopus oligosporous 2UV3 over a 120 hour period;

FIG. 5 depicts substrate ADF content during fermentation of DDGS by Rhizopus oligosporous 2UV3 over a 120 hour period;

FIG. 6 demonstrates decreases in substrate fat content during fermentation of DDGS by Rhizopus oligosporous 2UV3 over a 120 hour period;

FIG. 7 shows decreased substrate dry matter content during fermentation of soybean hulls by Rhizopus oligosporous 2UV3 over a 120 hour period;

FIG. 8 demonstrates increases in substrate protein content during fermentation of soybean hulls by Rhizopus oligosporous 2UV3 over a 120 hour period;

FIG. 9 demonstrates decreases in substrate NDF content during fermentation of soybean hulls by Rhizopus oligosporous 2UV3 over a 120 hour period; and

FIG. 10 depicts substrate ADF content during fermentation of soybean hulls by Rhizopus oligosporous 2UV3 over a 120 hour period.

Reference will now be made in detail to the present preferred embodiment of the invention, an example of which is illustrated in the accompanying drawings.

### DETAILED DESCRIPTION OF THE INVENTION

As discussed above, it is known to utilize fibrous byproducts and residues of various food manufacturing industries as animal feeds. It will be understood by those of skill in the art that by “food manufacturing,” it is meant both human and animal food/feed processing industries, and fuel and beverage alcohol industries. Examples include the brewing and distilling industries, the cereal manufacturing industries, and the like. Exemplary byproducts/residues generated by such industries include, but should not be considered as limited to, spent brewer's grains, dried distiller's grains, dried distiller's solubles, distiller's dried grains with solubles, residues of the cereal processing industry, wheat bran, soybean hulls, citrus pulp, sugar beet pulp, rice husks or hulls, bagasse, and mixtures thereof. Such byproducts/residues, while having value as animal feed products or supplements, are acknowledged to be of lesser nutritive value than conventional feeds such as soybean meal, due to their lower protein content. Producers, faced with slim profit margins, will often elect to utilize feeds of higher nutritive value to enhance animal growth rate and lean meat deposition, thereby hastening time to market and consumer acceptability.

In accordance with the identified need in the art, the present invention provides methods for improving nutritive value or quality of such fibrous byproducts or residues, comprising inoculating the byproducts with a filamentous fungus and fermenting them to produce a product having enhanced nutritive value to an animal consuming it. Typically, such fermentation will be a solid-state fermentation (SSF), which as is known in the art involves growth of a microorganism on a solid substrate having appreciable moisture content but not appreciable free liquid. Such SSF has been used for millennia, for example in production of Japanese sake. It will be appreciated that any suitable bioreactor may be utilized to accomplish the SSF, such as conventional tray systems, Koji chambers, or an enclosed bioreactor as is described in British Patent Appl. No. 0203335.5, incorporated herein by reference.

The following examples are presented for illustrative purposes only, and are not to be considered restrictive of the scope of the invention as otherwise described herein.

### EXAMPLE 1

A fermentation time course was conducted over a period of 120 hours using DDG obtained from a commercial fuel ethanol distillery.

Working slants of the filamentous fungus, Rhizopus oligosporus 2UV3, maintained on Potato Dextrose Agar, were used to inoculate a liquid medium of the following composition; glucose 5 g/L, yeast extract 18 g/L, KCl 0.5 g/L, MgSO₄.7H₂O 1.5 g/L, KH₂PO₄ 1.0 g/L, cornstarch 60 g/L and ground wheat bran 20 g/L.

Briefly, 2×3 mm squares of growth from a single slant were used to inoculate 200 ml of the liquid medium contained in a 500 ml flask. The culture was incubated at 30° C. for 2 days on an orbital shaker set at 200 rpm. This culture was then used to inoculate triplicate flasks corresponding to each time point of the time course study. Each flask contained 25 g DDG and 1.5 g soy flour as an additional source of nutrients to support fungal growth.

Twenty five milliliters of the two-day old seed culture was diluted in 500 ml sterile water. Fifteen milliliters of this dilution was used to inoculate each of the flasks containing the DDG substrate. Following mixing, the sealed flasks were incubated at 30° C. in a stationary incubator. At 0, 24, 48, 72, 96 and 120 hours, respectively, triplicate flasks were flash frozen and stored at −20° C., following which the flask contents were lyophilized. The dry weight of the substrate at each time point was recorded before the samples for each time point were subjected to laboratory analysis for crude protein, crude fat, acid detergent fiber and ash. The overall changes recorded are given in Table 1.

TABLE 1
Changes recorded over the course of fermentation of Rhizopus
oligosporus 2UV3 on DDG (dry weight basis)

| Component | Time 0 | Time + 120 hours |
|---|---|---|
| Dry Weight % | 100 | 93 |
| Crude Protein % | 30 | 42.7 |
| Crude Fat % | 10.3 | 4.33 |
| ADF % | 22.2 | 17.7 |
| Ash % | 1.56 | 1.87 |

It is clear that the solid state fermentation of DDG by Rhizopus oligosporus results in a material of reduced bulk, significantly enhanced protein content and reduced fat content. Similarly, the reduction in acid detergent fiber (ADF) content is significant from the perspective of using the final product as a value-added product for feeding to monogastric animals. ADF is composed mainly of cellulose and lignin which are not readily digested by monogastrics.

### EXAMPLE 2

This example demonstrates the ability of this fermentation system to produce valuable hydrolytic enzymes of fungal origin for use as direct feed additives in animal diets. The enzyme in this particular example is a fungal protease produced by the Rhizopus strain described in Example 1. Briefly, flasks containing the DDG/soy flour mix were inoculated as described in Example 1. Additional sterile water was added to generate final moisture levels of 43, 45, 46 and 18%, respectively. Triplicate flasks were inoculated for each moisture level. Flasks were incubated at 30° C. and 70-80% humidity for 5 days. The fermented DDG was then extracted in 20 volumes of warm water for 1 hour at 30° C. Extracts were assayed for fungal protease activity using a standard procedure and the activities present in each preparation were expressed as protease units (HUT) present per gram of starting DDG. Results are presented in Table 2.

TABLE 2
Protease production by Rhizopus on a DDG substrate.

| Moisture level | HUT/g DDG |
|---|---|
| 43% | 8,340 |
| 45% | 8,553 |
| 46% | 8,695 |
| 48% | 9,842 |

### EXAMPLE 3

The protease produced in Example 2 was directly compared with an existing commercial protease preparation in a chick growth assay. Protease extracted from fermented DDG was dried and adjusted to a final enzyme activity of 8,000 HUT/g powdered preparation; an activity identical to the aforementioned commercial preparation. The enzyme preparations were used to supplement a corn-soybean meal- based chick diet at a level of 0.5 g/kg and 1.0 g/kg, respectively. Diets were fed to 42 chicks per treatment group for 14 days from placement on the trial. Body weight gains recorded at the end of this period are presented in Table 3.

TABLE 3
Bird body weight gain (g) following dietary supplementation with
a commercial protease enzyme (ComP) versus the
DDG-derived protease (DP).

| Treatment | Body Weight Gain (g) |
|---|---|
| 0.5 g/kg ComP | 289 |
| 1.0 g/kg ComP | 300 |
| 0.5 g/kg DP | 307 |
| 1.0 g/kg DP | 296 |

It is clear from these data that both protease preparations resulted in similar bird performance, indicating that the DDG-derived protease is suitable as a direct feed additive in animal diets.

### EXAMPLE 4

Soybean hulls, a waste product of human food processing, were inoculated with the Rhizopus strain in the manner described in Example 1, the only difference being that soy flour was omitted from the fermentation. Additional water was added to bring the final moisture level to 47, 48 and 49%, respectively. Flasks were incubated exactly as described under Example 2, following which the fermented soy hulls were extracted and assayed for protease activity; again as described in Example 2.

TABLE 4
Protease activity resulting from solid
state fermentation of soybean hulls.

| Moisture Level | Protease Activity (HUT/g) |
|---|---|
| 47% | 2,619 |
| 48% | 2,530 |
| 49% | 2,181 |

Thus, it is clear that while the levels of protease produced on soybean hulls were considerably less than the levels attained on DDG, significant levels of protease enzyme can be produced on a range of byproducts from the food and alcohol industries. This is further illustrated in example 5.

### EXAMPLE 5

A fermentation time course was conducted over a period of 96 hours using a non-sterile wheat bran byproduct obtained from the human food industry. Seed cultures of Rhizopus oligosporus were prepared as described in Example 1 and were used to inoculate flasks containing 25 g wheat bran, another residue of a human food manufacturing process. Triplicate flasks were inoculated for each time point of the study and incubation was carried out at 30° C. at a relative humidity of 85%. At 0, 24, 48, 72 and 96 hours, respectively, flasks were flash frozen and stored at −20° C. At the end of the experiments, one flask from each time point was extracted and assayed for enzyme activity. The other two flasks were lyophilized and their contents analyzed for protein and total sugars (as sucrose). The results obtained are shown in Table 5.

TABLE 5
Changes recorded over the course of fermentation
of Rhizopus on wheat bran.

| | | Enzyme Activity | |
|---|---|---|---|
| Time (hours) | Protein % | (HUT/g) | Total Sugars % |
| 0 | 16.1 | NA | 6.0 |
| 24 | 17.5 | 430 | 5.8 |
| 48 | 18.8 | 2,760 | 1.8 |
| 72 | 19.1 | 4,300 | 1.5 |
| 96 | 19.4 | 2,820 | 1.4 |

As before, the overall result is a byproduct material which has been enriched in protein content and has provided the substrate for microbial growth leading to the production of useful hydrolytic enzymes.

### EXAMPLE 6

An experimental inoculum was prepared in the following manner: 2 Erlenmeyer flasks (250 ml) were used for the preparation of 2^{nd} seed cultures. Each flask was prepared with 12 g of cornstarch, 3.6 g of peptone, 1 g of dextrose, 1 g of yeast extract, 0.3 g of MgSO₄, 0.2 g of KH₂PO₄, 0.2 g of KCl, and 200 ml of distilled H₂O. The media was heated and mixed until all of ingredients were dissolved and the cornstarch had been caramelized. The flasks were then autoclaved at 121° C. for 20 minutes. After the flasks had cooled, each was inoculated with a Rhizopus oligosporous 2UV3 culture prepared on an agar (PDA) slant. The flasks were placed on a shaker (200 rpm) in an incubator at 30° C. and allowed to cultivate for 72 hours. After 3 days, the flasks were observed to ensure that the fermentation occurred without contamination and that the growth was mycelial in nature (rather than pellet form). The S2 cultures were diluted with sterile H₂O using a 1:21 (15 ml of culture added to 300 ml of H₂O) ratio as the final step in the preparation of the inoculum.

Six sets of five flasks containing 20 grams of DDGS were prepared and autoclaved at 105° C. for 30 minutes. The 30 flasks containing DDGS were inoculated with 12 ml of Rhizopus inoculum and 25 were placed in the incubator at 30° C., while the other 5 were set aside as the 5 samples for Time 0. 5 flasks were pulled from the incubator each day for samples corresponding to days 1-5 (24, 48, 72, 96, and 120 hours). The flasks were emptied and the contents were placed in a pre-weighed labeled petri dish and weighed on the balance. Each petri dish was then placed into a freezer. Once all the samples from each day were collected, weighed, and completely frozen, all of the samples were freeze-dried. After 7 days, the samples were removed and once again weighed on the balance.

Monitoring dry weight (weight after freeze drying) of each time point allowed determination of the dry matter evolution. In addition, a dry matter analysis was performed on each of the 30 samples after freeze-drying. Samples representative of each time point were analyzed for protease activity, for protein content using the Kjeldahl method, for fiber content (ADF and NDF), and for fat content.

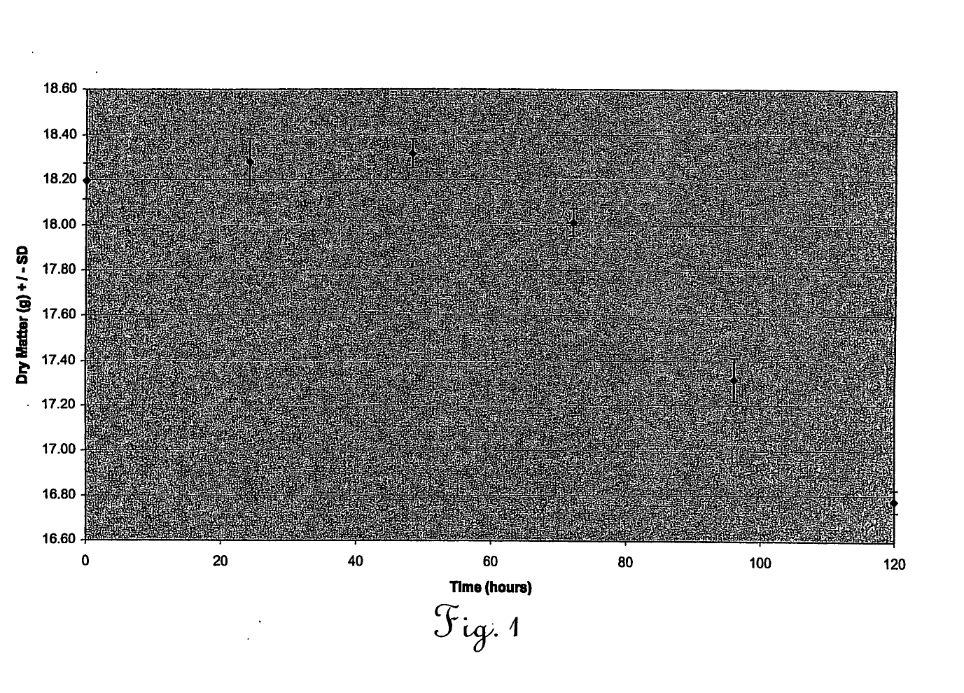

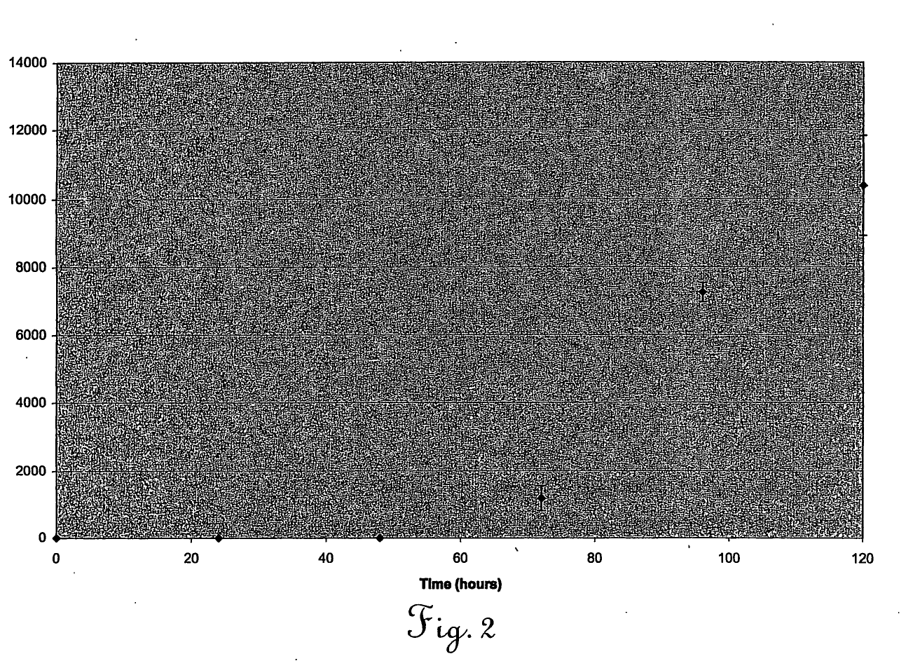

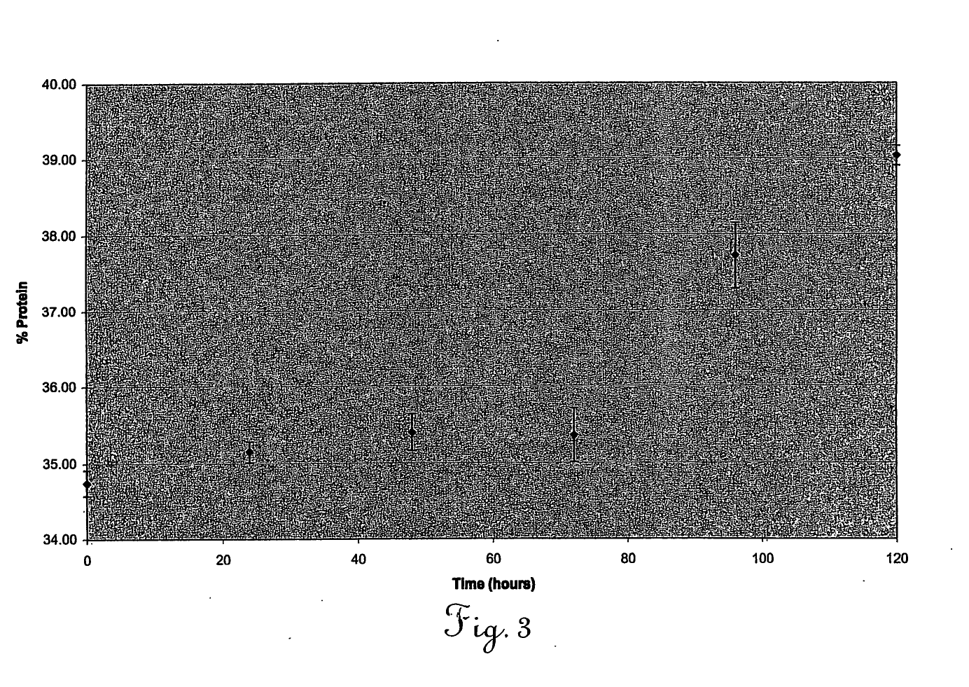

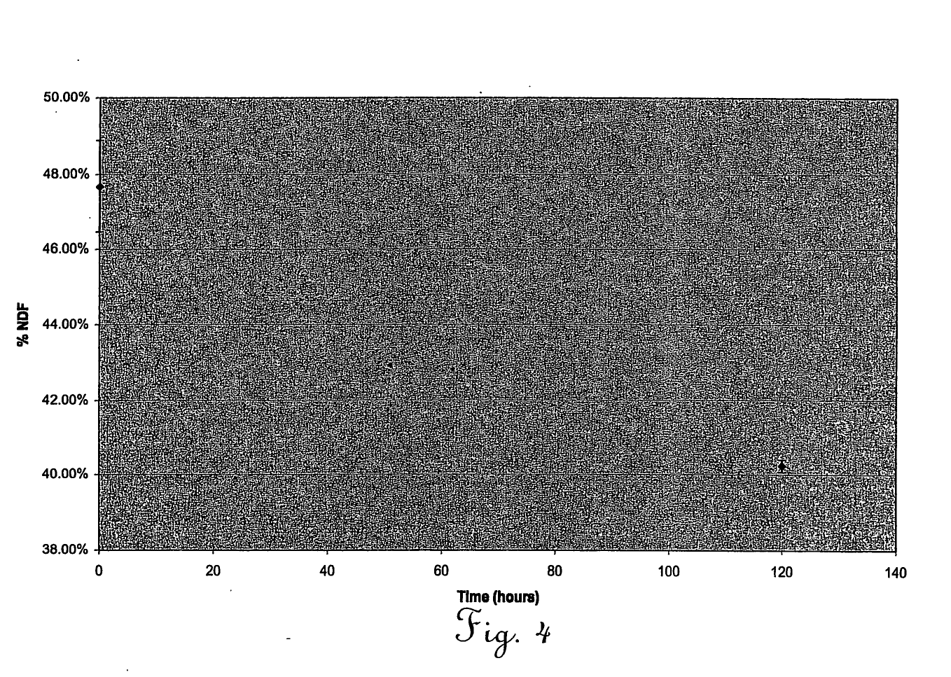

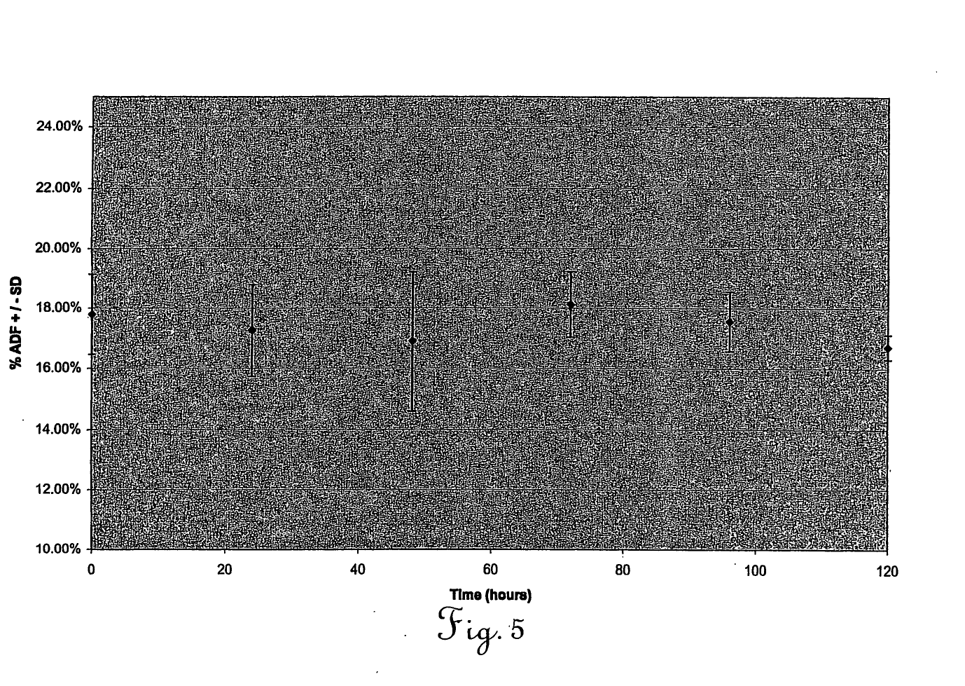

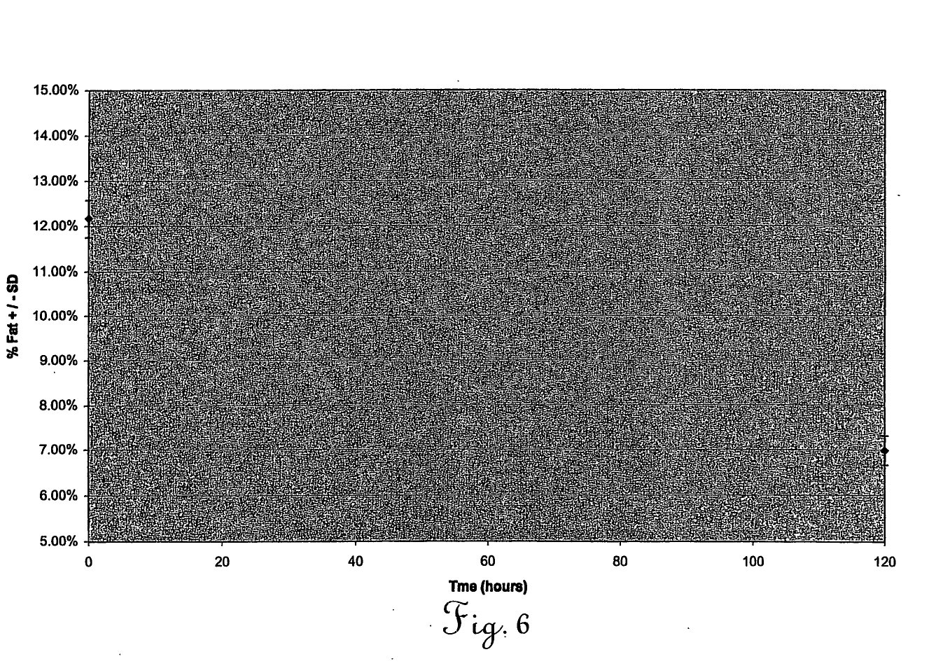

The average sample weight for Time 0 was 18.20 g and for 120 hours was 16.78 g, which is a decrease of 1.42 g or 92.2% of Time 0 after 5 days (FIG. 1). This difference is attributed to the digestion of the DDGS during fermentation and the production of CO₂. The average protease activity level after 120 hours was 10,235 HUT/g, compared to substantially no activity at Time 0 (FIG. 2). The average protein value for the samples from Time 0 was 34.7% and after 120 hours was 39.0%. An increase of 4.3 percentage units in protein corresponds to an overall increase of 12.3% in protein as a percentage of the sample (FIG. 3). Referring to FIGS. 4 and 5, fiber content of the samples also changed, with NDF decreasing from 47.7% to 40.2% and ADF decreasing from 19.4% to 16.7%. Fat content of the samples decreased from 12.2% to 7.0% at the end of the 5-day fermentation (FIG. 6).

It is therefore shown that the method of the present invention results in a feed or feed supplement having an increased protein content, decreased DM, fiber, and fat content compared to native DDGS. The average protease activity is significant, and suggests that a valuable co-product can be obtained in addition to the value added byproduct feed. The increase in the protein percentage along with the reduction of fiber makes the feed prepared by the method of the present invention more desirable as an animal feed source. The feed product can be fed to an animal as-is, including the enzyme co-product to beneficially influence digestibility, or in the alternative the enzyme co-product may be separated for a different use as described in Example 3.

### EXAMPLE 7

A time-course fermentation was prepared as described in Example 6, with the exception that soybean hulls were used as the byproduct on which fermentation was performed. Samples were evaluated for protease production, dry matter content, protein, and fiber content as described above. As shown in Table 6, while protease production did not reach the levels shown on DDGS, significant enzyme was produced.

TABLE 6
Protease activity produced by fermentation of Rhizopus
oligosporous 2UV3 on soybean hulls.

| Sample | Protease activity (HUT/g) | C.V. (%) |
|---|---|---|
| Time 0 | 332 +/− 154 | 46.52 |
| 72 hours | 3394 +/− 46 | 1.36 |
| 120 hours | 4653 +/− 161 | 3.45 |

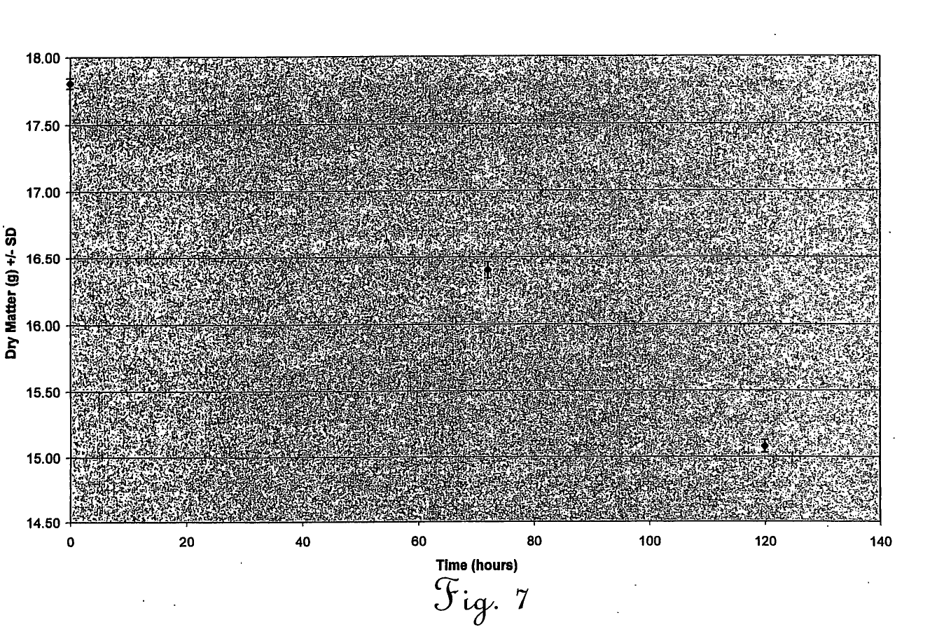

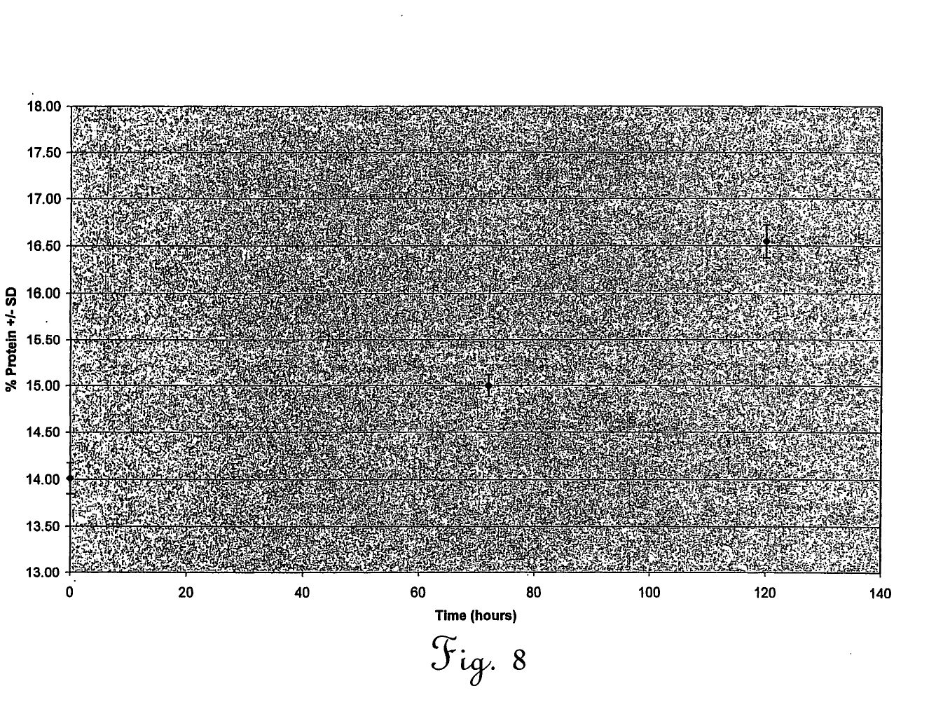

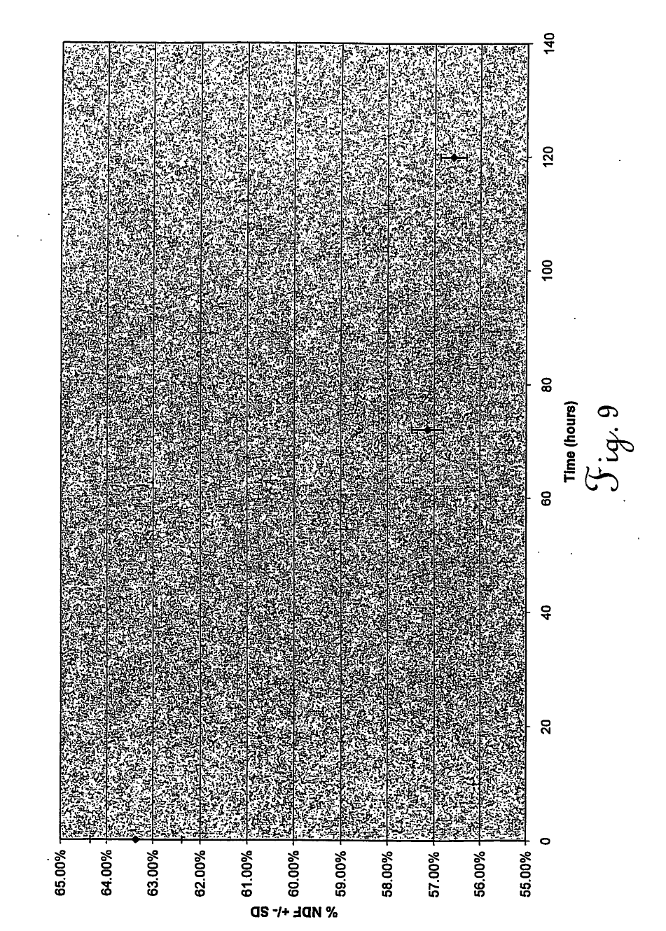

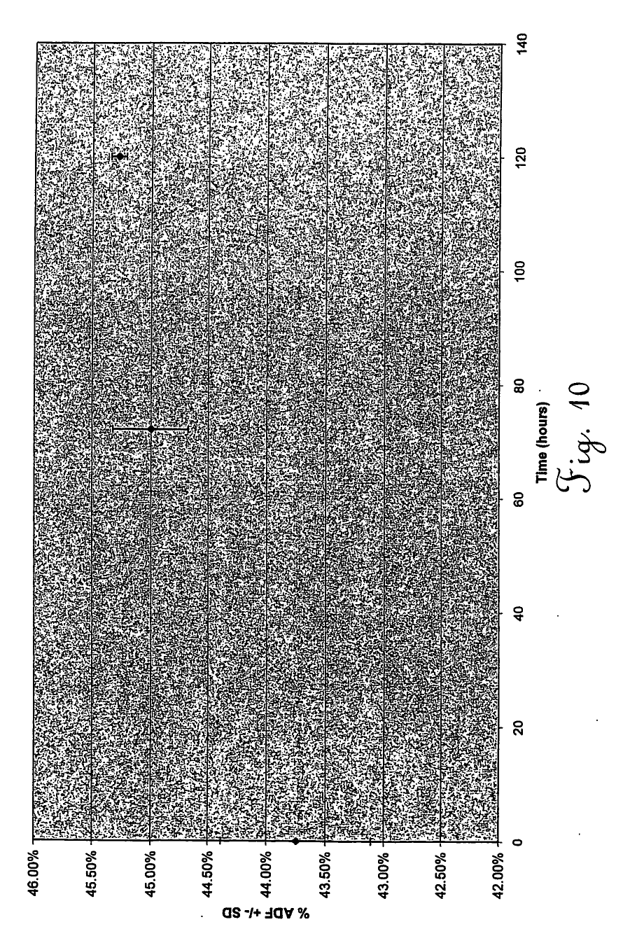

As was seen for DDGS, dry matter decreased (FIG. 7) and protein increased (FIG. 8) in the fermented soybean hulls. NDF decreased in the fermented samples (FIG. 9). However, in contrast to the results with DDGS, ADF remained relatively constant (FIG. 10).

### EXAMPLE 8

A 120 hour time course fermentation was prepared and conducted as described in Example 6. Samples of the final fermented DDGS byproduct were submitted to a contract laboratory to determine the amino acid profile of the resulting product by amino acid analyzer. As shown in Table 7, a significant increase in the content of the essential amino acid lysine of the product was observed (an increase of 33% from time 0 to time 120). This suggests that the method of the present invention may be suitable for preparing a feed, feed ingredient, or feed supplement for animals having a particular need for lysine. In particular, it is known that certain monogastric animals such as swine have especially elevated nutritional requirements for lysine.

TABLE 7
Amino acid content of the final product produced by fermentation
of Rhizopus oligosporous 2UV3 on DDGS.

Concentration (%)

| Amino acid | Time 0 | Time 120 |
|---|---|---|
| Lysine | 0.57 | 0.76 |
| Alanine | 2.18 | 2.03 |
| Arginine | 1.04 | 1.11 |
| Aspartic acid | 2.11 | 2.43 |
| Cystine | 0.52 | 0.58 |
| Glutamic acid | 5.37 | 5.01 |
| Glycine | 1.06 | 1.34 |
| Histidine | 0.72 | 0.67 |
| Isoleucine | 1.11 | 1.13 |
| Leucine | 3.70 | 3.30 |
| Methionine | 0.57 | 0.53 |
| Phenylalanine | 1.49 | 1.41 |
| Proline | 2.35 | 2.01 |
| Serine | 1.43 | 1.50 |
| Threonine | 1.12 | 1.25 |
| Tyrosine | 0.96 | 0.98 |
| Valine | 1.46 | 1.52 |
| Tryptophan | 0.20 | 0.28 |

It is accordingly shown herein that the present invention provides a suitable method for improving nutritive qualities of a byproduct or residue of various food/feed manufacturing industries, as well as the brewing and distilling arts. A value-added product is provided, as well as a valuable co-product in the form of an enzyme suitable for use as a feed supplement to improve growth rate of an animal consuming it.

The foregoing description of the preferred embodiment of this invention has been presented for purposes of illustration and description. It is not intended to be exhaustive or to limit the invention to the precise form disclosed. Obvious modifications or variations are possible in light of the above teachings. For example, protein requirements of various livestock are well known in the art, and fermentation conditions could be adjusted to arrive at a preferred combination of dry matter, protein, and fiber in accordance with the nutritional needs of the animal under consideration. Similarly, it is known that different filamentous fungi produce different enzymes of value in the feed industry, or can be induced to alter their enzyme production in accordance with the substrate provided. Accordingly, production of the enzyme co-product can be altered by adjusting the fibrous byproduct or residue used as a substrate for the fungus. Still further, additional nutrients could be added to the final fermentative product, such as trace minerals, vitamins, and the like, in accordance with the nutritional needs of the target species.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for improving the nutritional quality of a fibrous by-product or residue of a food manufacturing process, comprising:
inoculating the fibrous by-product or residue with at least one filamentous fungus; and
fermenting the fibrous by-product or residue;
whereby a dry matter content of the by-product or residue decreases, a protein content of the by-product or residue increases, and a fat content of the by-product or residue decreases.

2. The method of claim 1, wherein the filamentous fungus is selected from the group consisting of Rhizopus, Aspergillus, Trichoderma, and any combination thereof.

3. The method of claim 1, wherein the fibrous by-product or residue is selected from the group consisting of spent brewer's grains, dried distiller's grains, dried distiller's solubles, distiller's dried grains with solubles, residues of the cereal processing industry, wheat bran, soybean hulls, citrus pulp, beet pulp, rice husks or hulls, bagasse, apple pommace, and mixtures thereof.

4. The method of claim 1, wherein a dry matter content of the fibrous byproduct or residue is decreased by from about 7% to about 12%, a protein content of the fibrous byproduct or residue is increased by from about 10% to about 15%, and a fat content of the fibrous byproduct or residue is decreased by from about 40% to about 50%.

5. The method of claim 1, wherein fermentation is a solid-state fermentation using the fibrous byproduct or residue as a substrate for growth of the filamentous fungus.

6. A method for producing an animal feed and an enzyme-based animal feed supplement from a fibrous by-product or residue of a food manufacturing process, comprising:
inoculating the fibrous by-product or residue with at least one filamentous fungus;
fermenting the fibrous by-product or residue whereby a dry matter content of the by-product or residue decreases, a protein content of the by-product or residue increases, and a fat content of the by-product or residue decreases;
separating at least one enzyme from the fermented fibrous by-product or residue; and
providing the fermented fibrous by-product or residue and optionally the separated enzyme to an animal as a feed or feed supplement.

7. The method of claim 6, wherein the fibrous by-product or residue is selected from the group consisting of spent brewer's grains, dried distiller's grains, dried distiller's solubles, distiller's dried grains with solubles, residues of the cereal processing industry, wheat bran, soybean hulls, citrus pulp, beet pulp, rice husks or hulls, bagasse, apple pommace, and mixtures thereof.

8. The method of claim 6, wherein the filamentous fungus is selected from the group consisting of Rhizopus, Aspergillus, Trichoderma, and any combination thereof.

9. The method of claim 6, wherein the separated enzyme is of fungal origin.

10. The method of claim 9, wherein the enyzme is a fungal protease.

11. The method of claim 6, wherein a dry matter content of the fibrous byproduct or residue is decreased by from about 7% to about 12%, a protein content of the fibrous byproduct or residue is increased by from s about 10% to about 15%, and a fat content of the fibrous byproduct or residue is decreased by from about 40% to about 50%.

12. The method of claim 6, wherein fermentation is a solid-state fermentation using the fibrous byproduct or residue as a substrate for growth of the filamentous fungus.

13. An enzyme-containing animal feed or feed supplement, produced by the steps of:
inoculating a fibrous byproduct or residue of a food manufacturing process with at least one filamentous fungus; and
fermenting the fibrous byproduct or residue whereby a dry matter content of the byproduct or residue decreases, a protein content of the byproduct or residue increases, a fat content of the byproduct or residue decreases, and at least one enzyme of fungal origin is introduced into the fermented byproduct or residue.

14. A method for improving body weight gain rate of a growing animal, comprising feeding a nutritionally effective amount of an enzyme-based animal feed supplement formulated by the steps of:
inoculating a fibrous byproduct or residue of a food manufacturing process with at least one filamentous fungus;
fermenting the fibrous byproduct or residue whereby a dry matter content of the byproduct or residue decreases, a protein content of the byproduct or residue increases, and a fat content of the byproduct or residue decreases;
separating at least one enzyme from the fermented fibrous byproduct or residue;
dewatering the separated enzyme; and
providing the dewatered enzyme to an animal in a formulation including a suitable carrier.

15. The method of claim 14, wherein the fibrous byproduct or residue is selected from the group consisting of spent brewer's grains, dried distiller's grains, dried distiller's solubles, distiller's dried grains with solubles, residues of the cereal processing industry, wheat bran, soybean hulls, citrus pulp, beet pulp, rice husks or hulls, bagasse, apple pommace, and mixtures thereof.

16. The method of claim 14, wherein the filamentous fungus is selected from the group consisting of Rhizopus, Aspergillus, Trichoderma, and any combination thereof.

17. The method of claim 14, wherein the separated enzyme is of fungal origin.

18. The method of claim 17, wherein the enyzme is a fungal protease.

19. The method of claim 14, wherein the animal is selected from the group consisting of an avian, a bovine, a porcine, an equine, an ovine, a caprine, a canine, and a feline.

20. The method of claim 14, wherein a dry matter content of the fibrous byproduct or residue is decreased by from about 7% to about 12%, a protein content of the fibrous byproduct or residue is increased by from about 10% to about 15%, and a fat content of the fibrous byproduct or residue is decreased by from about 40% to about 50%.

21. The method of claim 14, wherein fermentation is a solid-state fermentation using the fibrous byproduct or residue as a substrate for growth of the filamentous fungus.
